(19) United States
(12) Patent Application Publication
(10) Pub. No.: US 2009/0106017 A1
(43) Pub. Date: Apr. 23, 2009

(54) Acceleration Method And System For Automatic Computer Translation

(76) Inventor: Giovanni D'Agostini, Udine (IT)

Correspondence Address: ST. ONGE STEWARD JOHNSTON & REENS, LLC, 986 BEDFORD STREET, STAMFORD, CT, 06905-5619, US

(21) Appl. No.: 12/210,863

(22) Filed: Sep. 15, 2008

Related U.S. Application Data
(63) Continuation of application No. PCT/EP2007/002086, filed on Mar. 12, 2007.

(30) Foreign Application Priority Data
Mar. 15, 2006 (IT) UD2006A000067

(51) Int. Cl. G06F 17/28

(52) U.S. Cl. 704/3

(57) ABSTRACT

Computerised automatic translation method characterised by the use of multi-tasking with two processors or a dual core that duplicates the system into two twins, one becoming server of the other and instructing the first to send a remaining part that is less than half to the second while the first begins the translation of the first part to then, on completion of its work, pick up the text translated by the second and joint it to the first part that has already been translated.

### CROSS-REFERENCE TO RELATED APPLICATIONS

The present application is a continuation of pending International patent application PCT/EP2007/002086 filed on Mar. 12, 2007 which designates the United States and claims priority from Italian patent application UD2006A000067 filed on Mar. 15, 2006, the content of which is incorporated herein by reference.

### FIELD OF THE INVENTION

This invention relates to an acceleration method and system for computer translation system, whose characteristics conform to the pre-characterising part of the main claim. Its use is substantially aimed at the translation of electronic texts, namely of texts available in an electronic format to be processed by the computer in a substantially automatic way with possible post-editing.

### BACKGROUND OF THE INVENTION

The prior art contains a very large variety of systems and methods for computer translation.

In computer translation greater speed is still always required, particularly for longer texts.

A further problem is that the result of computer translation is generally poor and thus obliges the translator or reviser to waste a notable amount of time correcting the translation.

The correction work is so notable for the reviser or translator that it is not convenient to use a computer translation, namely an automatic translation.

US 2001/029442 A1 in the name of SHIOTSU MAKOTO ET AL disclose “a translation system having a translation receiving device that receives a source document to be translated, divides the source document into specified units of text, produces translation control information corresponding to the respective specified units and requests translation of the text. A translation device receives the text from the translation receiving device, and translates the text using the translation control information.” This solution being a sequential solution having the scope to previously dividing paragraphs (split sentences) in sentence-by-sentence way with option 1 or 2, etc. The suggested solution also using more processors is anyway sequential, because need analysis of sentence after sentence, because sentences must be recombined after translation in the progressive original sequence. The solution not being able to accelerate automatic translation, because the splitting into sentences and the respective options are not able to accelerate the automatic translation.

The present invention is still to accelerate the automatic translation in respect of any kind of machine translation and also in respect of this prior art of WO 02/054280 A without needing to separately translate sentence by sentence.

The time lost on corrections could be reduced with highly sophisticated systems but they require further processing of the text and thus longer waiting times for the translation. A first aim is to accelerate automatic translation.

WO 02/054280 A in the name of the same applicant and same inventor of this invention, disclose an automatic computer translation system and postediting system for better improving the translation with the intervention of the operator in postediting. This system working basically by a combination of source language to target language, namely performing first an automatic translation from source to target language. Disclosing furthermore words/fragments improving means from said source language to target language to be stored for reuse in the same machine translation.

If this solution strongly improve better man-computer translation, namely interactive translation, has the drawback of needing the intervention of human operator, furthermore source to target has always a strongly limited quality result also if continuously improving deriving from post-editing new teachings of words/fragments of source language to target language allows performing improved machine translation.

U.S. Pat. No. 6,161,082 discloses a network based language translation system using different language computers (100,120,110) interconnected by a network having inside the network language translation software (160) and a DataBase (170).

XP007905053 (PETER DIRIX et al.) 2005-09-12 discloses an example-base machine translation using bilingual corpora combined with monolingual corpora. My previous Application WO 02/054280—IT-UD2000A00228 28.12.2000 uses also combination of bilingual corpora (Source Language to Target Language) with monolingual corpora (Target Language to Target Language)—See page 19, lines 10 to page 17 line 20 and page 46 lines 19-25—.

In this description and claims, the definition “line” always refers to an electronic line, that is to say a line that comprises an entire paragraph, namely not fragmented by returns, with a fixed number of characters in the old MS-DOS or Windows of UNI-X system. In other words, “line” refers to at least one complete paragraph or title, etc, defined by a return in the sense disclosed above that normally but not always is defined by a full stop and a new paragraph.

### SUMMARY OF THE INVENTION

The main object of the invention is to increase the speed of automatic translation. A second aim is also to increase the quality of computer translation. A further aim is to reduce translation completion time.

The problem is solved with the characteristics of the main claim. The sub-claims represent advantageous preferred solutions that provide optimal efficiency.

In this way, translation speed is almost doubled thus almost halving the waiting time. A further aim is that of improving translation through two different types of teaching:
a) teaching of the corrections from the source language to the target language:
b) teaching of the corrections from the target language from the translation to the final revised target language.

In this way the teachings are more complete and produce an improved translation given that with the teachings from the source language to the target language it is certainly not always possible to obtain a good translation, depending on a number of different variables in the target language and respective rules and exceptions that render total control impossible even with the most advanced automatic translation systems.

In this way, by constantly and rapidly improving the translation thanks to the use of this new additional auto-learning engine, according to the present invention, using the process of the target language also towards the target language, there are very notable advantages, such as:
improvement of the efficiency of the entire work;
increase in final product quality;
remarkable reduction in the production time required to obtain a very good finished product, namely the translation and at the same time also its revision that is due to the fact that the system has the capacity to allow the operator to teach revision amendments from the beginning that will be used for the entire following text of the same translation and that will be carried out automatically by the computer which will correct said errors in a much faster way with respect to that which can be done by the human operator, thus notably reducing the completion work of the finished product (translated and revised text).

### BRIEF DESCRIPTION OF THE DRAWINGS

For an improved understanding, the invention is described in a preferred solution by means of the included schematic diagram, wherein:

FIG. 1 represents a schematic view of the system online with the representation of the interface of a translator/reviser stand-alone computer display, after automatic translation (Cuz, SourceRev, TargetRev; sources, TargetDB).

FIG. 2 represents the first operative stage with the visualisation of how the respective automatic translation is obtained on said interface in the couple of lower fields with the source text (SourceS) on the left and the resulting automatic translation (TargetDB) on the right.

FIG. 3 represents the subsequent post-editing stage carried out in a semi-automatic way by the operator in which the operator, having seen that the first line is considered correct, presses the OK command to make said line move automatically to the couple of the upper field (SourceRev, TargetRev).

FIG. 4 represents the first correction action with a window interface in which the correction is presented showing the error “solution preferred” that automatically appears in the window.

FIG. 5 represents the same previous window in which the operator has already carried out the correction on “preferred solution”, a correction that is automatically made in the text and memorized as a teaching, this being a teaching of the second type according to the present invention, namely from the automatic exiting language to the same corrected language.

FIG. 6 represents the continuation of the teaching with the opening of a new window in which the correct translation of the fragment concerned is reported in the penultimate line and in the last line its qualification is given as an instruction code (in this specific case singular neutral noun “sons”), below the item portion of the corresponding source text the operator is invited to select the corresponding part (selected part=“soluzione preferita” of the portion of the paragraph of the source language).

FIG. 7, after the OK command the additional window that automatically appears proposes the teaching with the respective instruction code. Said teaching is of the first type, that is to say from source text to target text, namely from source language to target language.

FIG. 8 represents the modification automatically made in the target text, a modification that will automatically be carried out in all the subsequent translations. The translations are carried out again each time each paragraph arrives at the first line, thus already improving the translation previously made.

FIG. 9 represents the automatic teaching by means of a window, in a similar way to the previous way but of the second type according to the present invention, namely after correction: from the exit language to the exit language, namely from the translated text to the corrected text. In this way, this type of correction is valid for any source language as they are corrections that otherwise could not always be made using the teaching of the first type. For example, “thereby of the included” with “by the enclosed”, in this way all the subsequent translations will also be formed with this teaching of the second type (in this specific case from English to English) thus improving the harmony of the sentence, a harmony that would not be attainable with only the teaching of the first type or only with corrections of an orthographic nature, as is the case for the common editing correctors in W.P.

FIG. 10 represents the next stage in which the previous line (paragraph) after correction has been moved to the upper couple.

FIG. 11 represents the following stage in which the line in FIG. 10 after consideration has been moved in turn to the upper couple. Thus the completion cycle of the translation is repeated until the end.

### DETAILED DESCRIPTION OF THE INVENTION

In accordance with the claims, the translation and revision system require at least one post-editing translation system, the translation engine being integrated into the computer or external to it, e.g. by the Internet.

According to the Figures, it must be observed that the system of this invention requires:
a) at least one interface with a couple of fields in order to include the text of the source language (SourceS) and that of the target language (TargetDB), preferably with at least a second couple of the same fields where the revised translation is stored (SourceRev, TargetRev);
b) means to store modifications from the source language towards the target language carried out by an operator after automatic translation or during interactive translation;
c) means to store modifications from target language to target language carried out by an operator after automatic translation or during interactive translation.

Advantageously, said couple of fields includes two adjacent parallel fields that slide simultaneously and are self-proportioned (sourceS-TargetDB, SourceRev-TargetRev) in order to show the same paragraphs (lines) at the same level, even if the two opposite texts have different lengths.

Advantageously, the two pairs of fields respectively consist of:
a—the lower field representing on the left the text to be translated (SourceS) and on the right the translated text (TargetDB) and
b—the upper field representing the couple of the revised part of the texts (SourceRev, TargetRev), said texts being passed line by line from the lower couple to the upper couple by means of a command action of the operator after the revision and correction has been carried out line by line.

The upper couple thus representing:
the target text completely amended and revised of the translation (TargetRev) on the right, and
the corresponding original source-text used for the translation (SourceRev) on the left, this is carried out by means of a parallel transfer control from the lower couple to the upper couple in the same number of paragraphs (lines), from the lower couple (sourceS-TargetDB) to the upper couple (SourceRev-TargetRev) until the end of the revision.

Auto-Learning and Auto-Improvement During Correction and Revision

Up until now, it has been practically impossible to allow the computer to auto-learn in order to auto-improve itself immediately for translation in the case in which the automatic translation process had been carried out online by a different unknown independent server (e.g. translation received via Internet or intranet or an equivalent connection).

With this invention an auto-learning engine is supplied inside the stand-alone system with the aim of memorizing at least the corrections made in the target language towards the target language so that they can immediately and continuously be reused without having to wait for the improved efficiency of the server-translator.

Obviously if the system also contains a translation engine, the first type of teaching can also be carried out, namely teaching from source language towards the target language in a parallel or sequential process (e.g. a dual core processor or dual processor systems or both e.g. “MAC Quad” with two “Dual-Core” processors).

In order to accelerate the translation system, the adoption of the following system, method and process is provided as claimed:
a) use an integrated multiple-tasking computer system with at least two processors,
b) duplicate the translation system by creating an identical couple of “stand-alone” translator systems working independently in said computer,
c) create a text container capable of receiving texts from said couple of translator systems or of allowing the reading of texts from said couple of translator systems,
d) activate one translator system of said couple as server of the other and the other as main translator so that both may have access to said text container, said server being equipped with means activated for continuously inspecting said container to verify if there are texts to be translated and, if the presence of a text is verified, providing the respective automatic translation and sending back the translation to said text container:
e) divide substantially into two parts the text to be translated in which the first part to be translated has a greater number of words than the second part and simultaneously:
f) send said second part to be translated to said container, while starting the translation of the first part to be translated in said main translator:
g) on completion of the translations in said main translator:
   i—command said main translator to verify if said container contains the translated text of the second part and
   ii—if said translation has been completed, add it to said first part and close the operation,
   iii—otherwise if said translation has not yet been completed by said server, provide directly for the completion of the translation.

In this way practically almost double the translation speed is achieved.

In the case that this does not occur, nothing is changed and the translation time remains unchanged.

Correction Instruments

The user system advantageously contains memorization means for the corrections made and storage of said corrections at least for the exit/target language(s) where the uncorrected word and/or sentence fragment of the automatic translation and the corresponding correction in the same exit/target language are memorized.

In this way, an automatic memorization of the corrections can be carried out by human control or can be activated automatically.

In this way, in accordance with the invention, teachings in progress are automatically reused sequentially not only for the remaining text that must be revised but also for each subsequent translation in the same exiting target language and given that is has the advantage of being independent from the source language it can also work for other translation couples in different languages, since this second type of teaching, only being valid for the target language, does not depend on the source language.

For example, if the target language to target language correction for the target language Italian is “de il” to “del”, obviously this is not only valid for translation corrections from English to Italian but also from German to Italian, from French to Italian, from Spanish to Italian, from Portuguese to Italian, etc and therefore, there is a reduction in memory and complexity and it improves the uniformity and thus the quality of the final translation, independently of the source language.

With this method the following is obtained:
reduction of memory size;
the same teachings are used independently of the source language, so for example, if the translation, namely the exit target language is Italian, the correction will be carried out independently of the fact that the source language is different: English, German, French, Spanish or Portuguese etc., and this correction(s) immediately works for all the immediate future translations without having to wait for the improved efficiency of the server-translator or automatic translation engine since, after learning it intervenes immediately and automatically after translation, in an autonomous way,
this naturally improves the quality of the translation and automatically corrects the errors also made by the automatic translator.

In other words, if the correction for the Italian target language is from “la cane” to “il cane”, this correction will be valid for each source language because the correction is carried out only and exclusively in the exit target language, namely in this specific case in the Italian language and therefore said correction is also valid for other source languages if the same error is verified.

Given that the teaching is automatically accumulated in a stable memory, it will be reused indefinitely unless the operator wishes to eliminate or change it.

The advantage of this type of method and process is obvious, largely because it is able to reduce manual corrections while not preventing the use also of instructions for pairs of different languages, said instructions for language pairs being used by the computer-translator or server-translator.

In this way it is evident that in principle the corrections from target language to target language, that are automatically stored in a memory as teachings from target language to target language, will be continuously and directly reused by the computer as teachings.

Advantageously, teachings from target language to target language include three elements, namely:
a) the erroneous fragment in the target language;
b) the amendment of the above;
c) an instruction code to allow the correction engine to carry out the correction in an improved way, respecting the rules of the target language in relation to the previous part of the processed text and the subsequent part of the text to be processed.

Therefore, for example, the teaching of the correction of “de la” will be: “de la, delta, prepart” wherein “prepart” constitutes the instruction code that will allow the computer to adapt the correction carried out in accordance with the sentence, changing it to “dell” or “della” or “dello”. For example, if the following first character of the next word starts with a vowel (a, e, i, o, u, or if first or the first two characters of the following word produce a strident sound such as e.g. “stridio, scivolo, etc.).

Obviously the system can be included in:
I. a purely automatic translation using said teachings from target language to target language and/or
II. semi-automatic translation or human quality translation revised by an operator in the respective interactive translation.

It can also be used to allow teachings from target language to target language to be reused immediately.
III. both functional in translation:
a) producing a translation from the source language towards the target language and
b) producing an automatic conversion of the translation with the engine from target language to target language.

Process

The translation process is carried out as follows:
a) the system having two superimposed couples of parallel sliding fields (SourceRev-TargetRev, SourceS-TargetDB) and
b) after the translation has been carried out and requiring revision, said source-text or text to be translated is placed in the left field (sorgenteS) of a lower couple of the interface of the respective computer, said automatic translation being placed in a right field (TargetDB) of a lower couple of said two superimposed couples of fields to allow the following steps:
   I. control line by line to see if the translation is correct and carry out the corrections in the target text on the right lower field (TargetDB) with reference to the corresponding paragraph of the source text in the left field (sorgentS);
   II. by means of automatic auto-learning means through the detection of the modifications of the detection means of the text variations of the computer system, the corrections made are identified that are automatically memorized for immediate reuse in the following sentences and in subsequent or future translations;
   III. the upper left and right couple/s of sentences/lines of the texts in said couple of lower fields to be revised (sorgenteS, TargetDB), being transferred in connection and in parallel to the upper couple of revised-text text fields (SourceRev.TargetRev);
   IV. the cycle is repeated until the end;
   V. at the end of the revision, both the source text on the left and the revised target text on the right are ready to be used in said upper couple (TargetRev, SourceRev.TargetRev).

Advantageously, after completion of the revision,
a)—sending means automatically open an e-mail provided to send the corrections (error and correction plus the respective instruction code) to a predetermined target section having the purpose of improving the translation system so that these errors will not only be considered in the present independent translation engine in use, but will also be sent to an engineering department on the mainline for the updating of future releases of the server translator (Main-Server), while the user's system already uses said corrections already stored in its own memory from the moment in which they were made,
b)—in a separate independent stage, the opportunely evaluated corrections sent via e-mail will be inserted into the future releases intended to replace the translator of the respective translator computer/translator servers.

In one solution, the translation system is placed in a stand-alone computer.

An advantageous solution is of the type with a connecting structure with network/Internet intercommunication (NET), whose network includes a plurality of interconnected servers (Serv1.Serv2.Serv3 . . . ServCUz . . . ServCUz), characterised in that it comprises:
a) at least one network communicator microprocessor user apparatus (Cuz) for network communication (CU1.CU2.CU3 . . . ) which comprises connecting means to the network and/or via network/Internet, and
b) at least one network server (ServerCTRn) connected to said intercommunication network/Internet (NET) including an indefinite number of servers (Serv1.2 . . . );
c) said network service server (ServerCTRn) including or connecting to at least one database for network service (Db); and
d) a plurality of translation computers and/or translator servers (Ctrn) comprising at least one internal automatic translation system for a plurality of languages in various combinations, each said server-translator for computer translation and/or (Ctrn) including furthermore:
   I. connection of means to said intercommunication network/Internet (ServCUz-network) and
   II. automatic and repetitive supervision means in said database (c) for network service (Db) to verify if at least one text to be translated has been loaded,
   III. respective pick up/download means of said text to be translated (SourceS),
   IV. means to translate at least automatically said text to be translated (SourceS) in order to obtain a translation (TargetDB) and
   V. means for automatically sending said translation (TargetDB) to said database by network service (Db), in order to continue the inspection for new texts in said database by network service (Db);
e) said network-connected user's computer a) (Cuz), similarly comprising:
   I. means for sending data and said text to be translated (SourceS) to said database c) by network service (Db),
   II. means to inspect said database by network service and to verify if the respective translation has arrived (TargetDB), and
   III. respective pick up/downloading means of said translation (TargetDB),
f) thus said network-connected user's computer can communicate by introducing data and sending the translation to be carried out and receiving the completed translation, only and exclusively with said database c) by network service (Db);
g) and therefore said translator computer and/or server-translator (Ctrn) communicate by introducing and capturing data, in the pick up/downloading and release stages of the translation only with said database c) by network service (Db),
h) said network service server d) (ServerCTRn) including interruption means or can be without means to allow the direct connection between said network-connected user's computer a) (Cuz) and said computer and/or network translator server d) (Ctrn).

The method and system for executing the stand-alone solution is the following:
a) a user's apparatus which is network connected (network-connected user's computer) (Cuz) is used with a translation post-correction device, said translation post-correction device having two superimposed couples of parallel sliding fields (SourceRev-TargetRev, sorgenti-TargetDB) and
b) after pick up/download, the translation requiring revision, said translation is placed on a field (TargetDB) of a lower couple of said two superimposed couples of fields to allow the following stages:
   I. control line by line (paragraph by paragraph) to see if the translation is correct, making the corrections in said text under-revision on the respective lower field (TargetDB) with respect to the corresponding paragraph of the source text of the opposite field (SourceS);
   II. by means of automatic auto-learning means through the detection of modifications, predisposed in said network-connected user's computer (Cuz), the corrections requested to be carried out are automatically memorized for immediate reuse in the subsequent text to be considered and in subsequent and future translations;
   III. the upper couple(s) of sentences/lines of the texts on the right and left revised in said couples of lower fields (SourceS, TargetDB), being transferred in connection with revised and corrected texts in an upper couple of revised-text fields (SourceRev.TargetRev);
   IV. the cycle is repeated until the end;
   V. at the very end of the revision, the entire revised text, respectively source text on the left and target text on the right, are ready to be used on said upper couple (TargetRev, SourceRev.TargetRev).

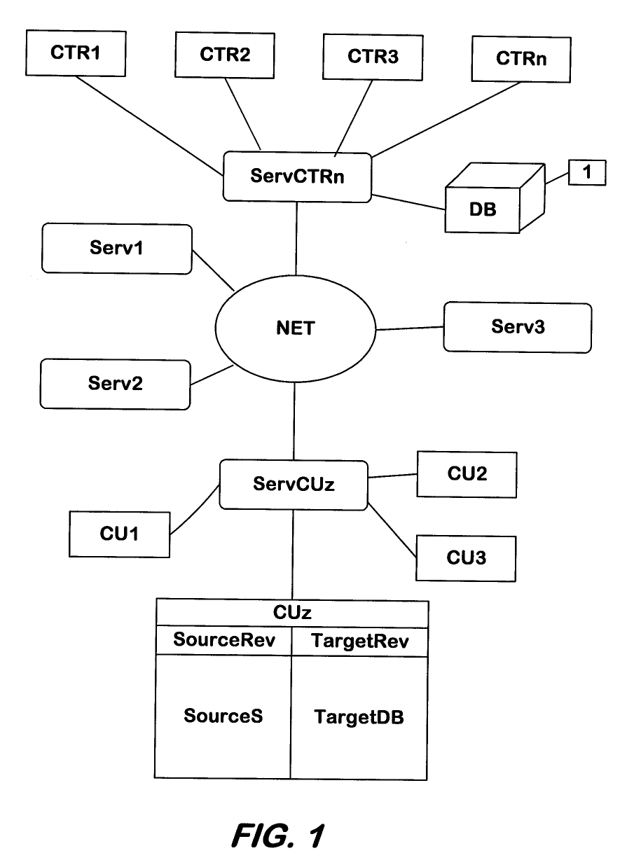

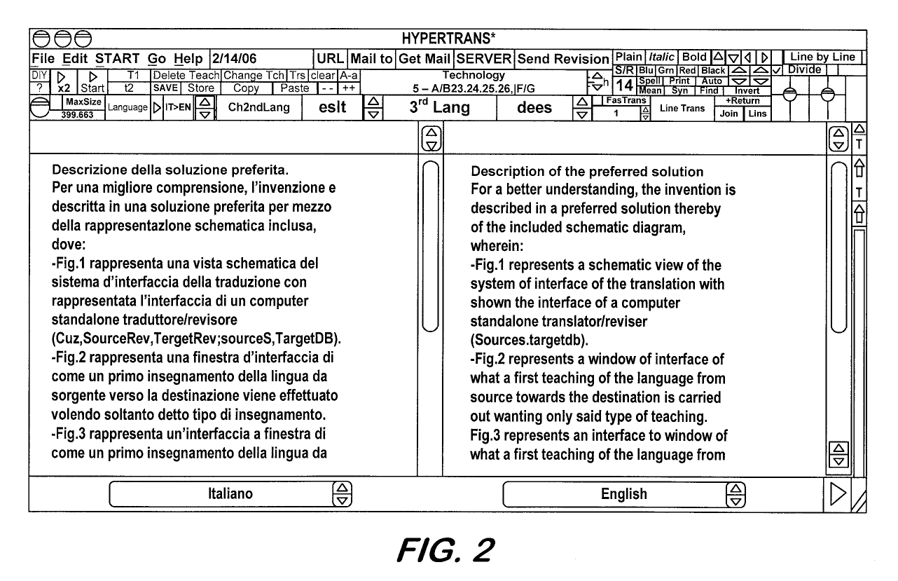

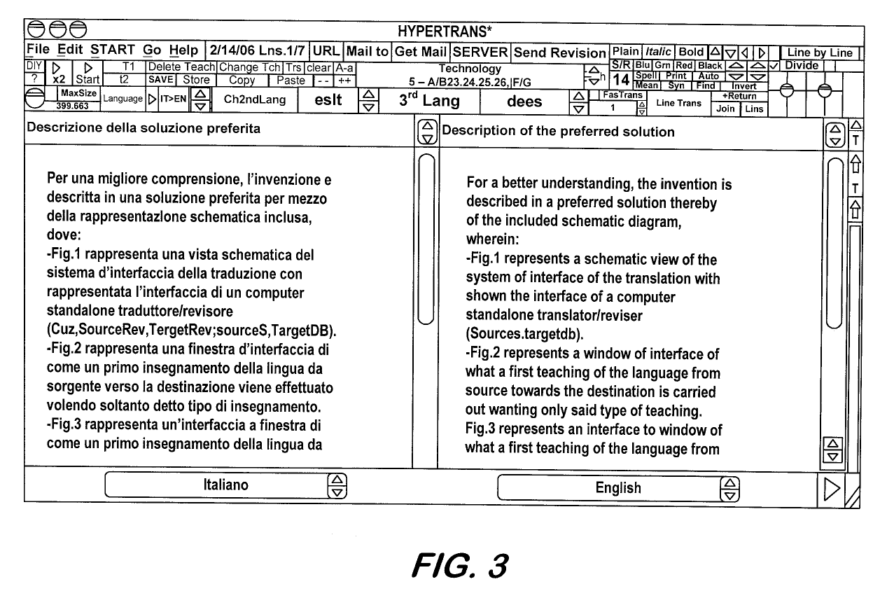

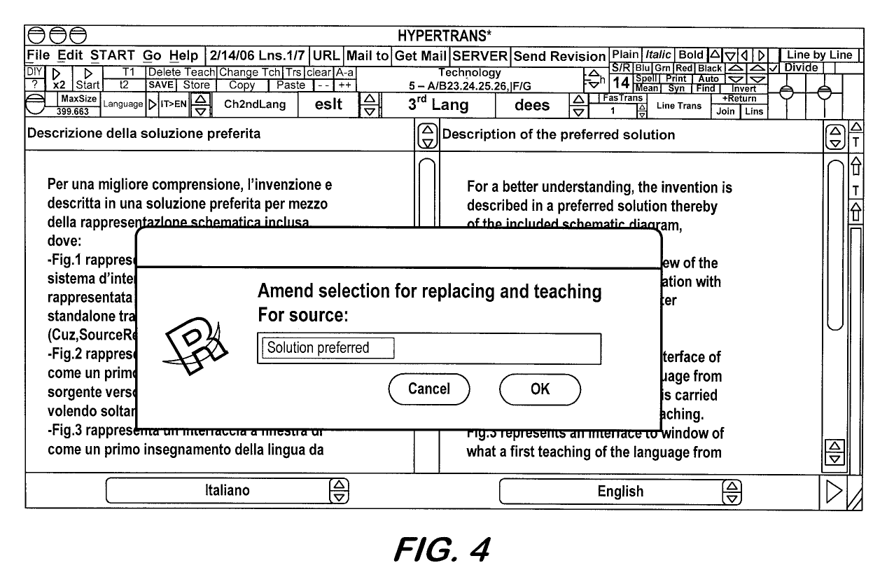

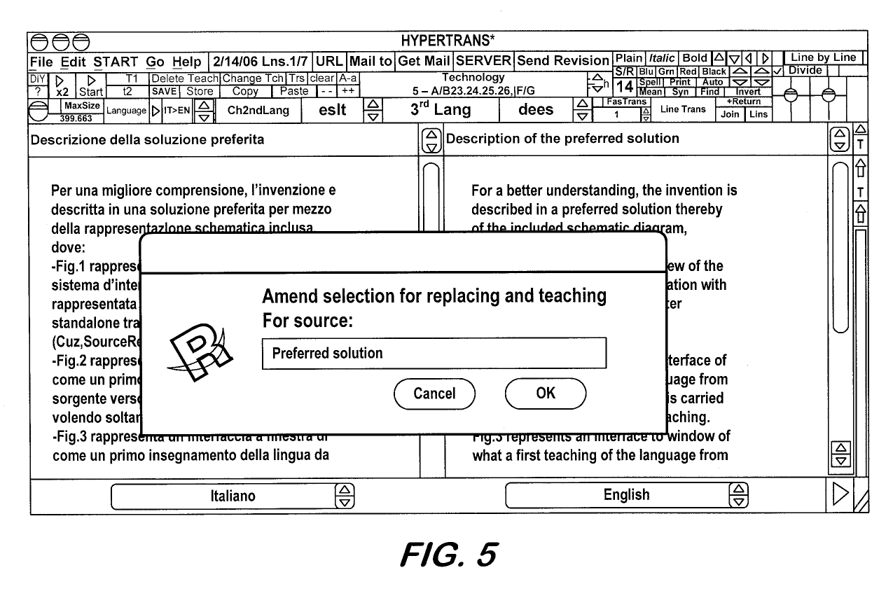

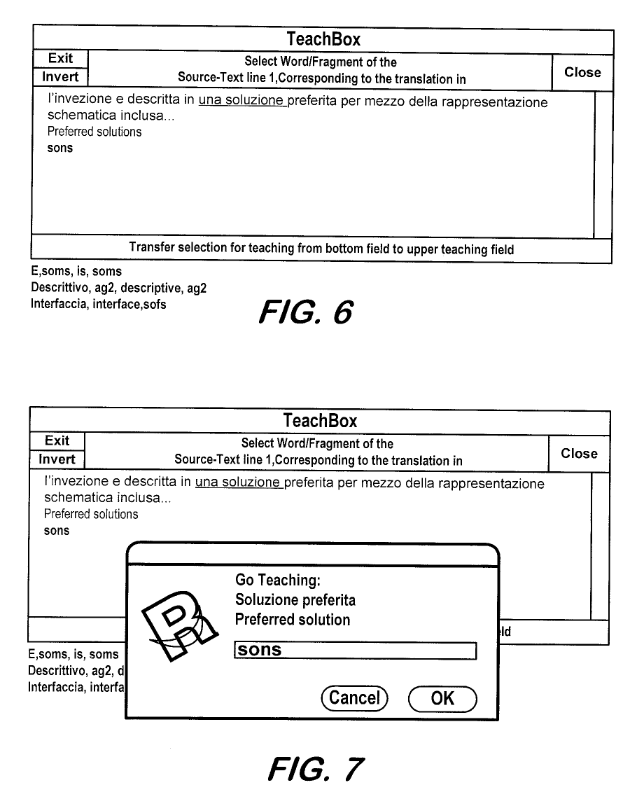

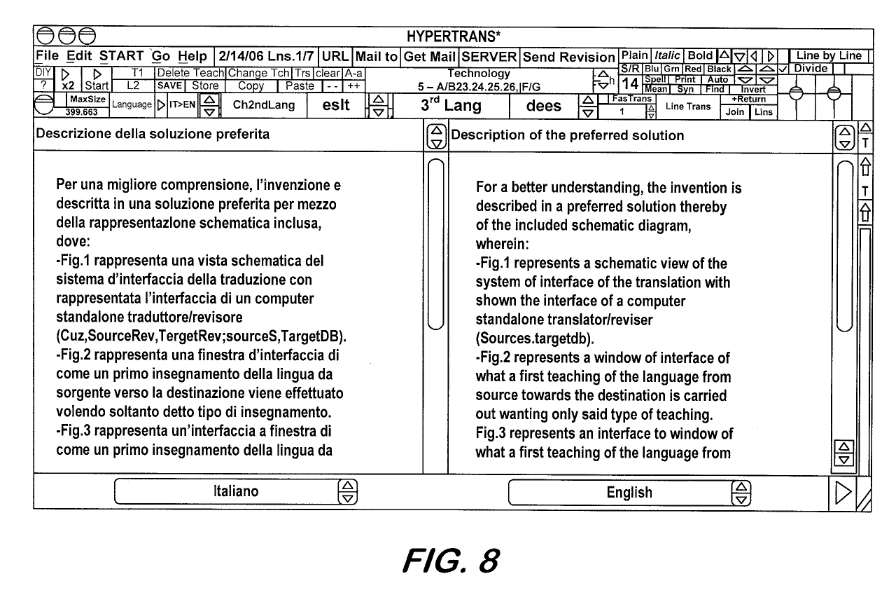

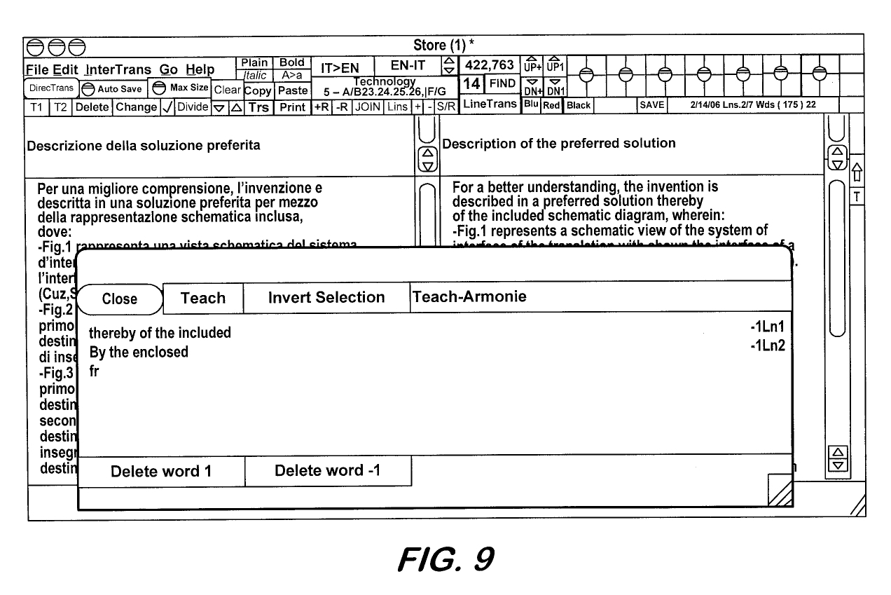

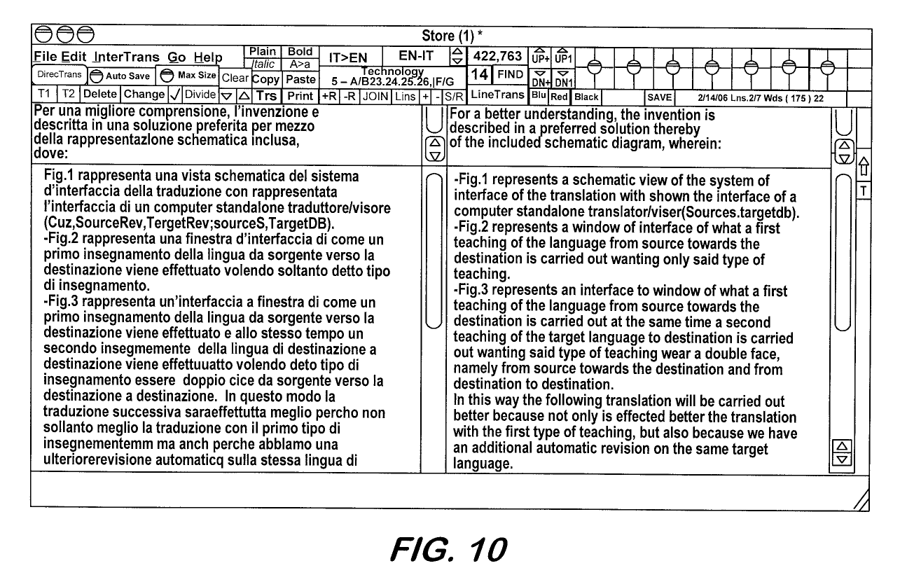

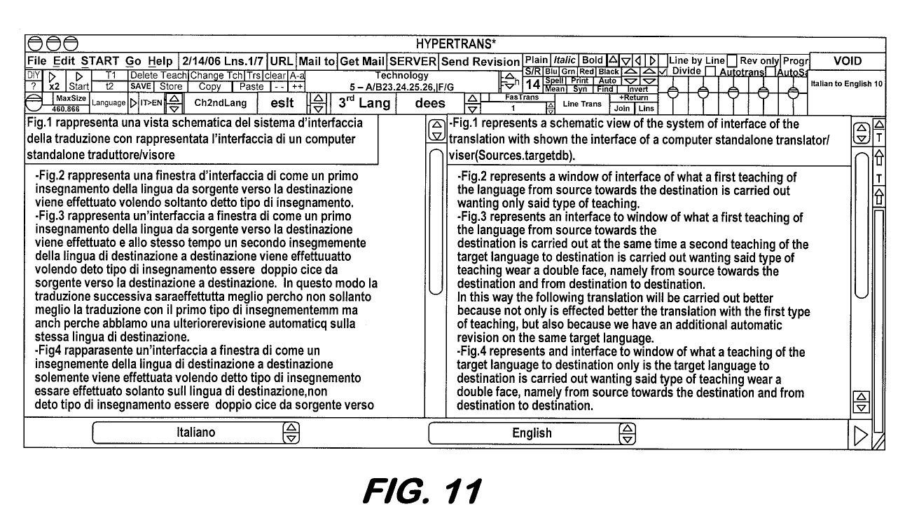

The cycle can also be clearly understood from the set of FIGS. from 2 to 11.
a) Automatic translation in the couple of lower fields with the source text on one side (SourceS″ and on the other side the resulting automatic translation (TargetDB) FIG. 2.
b) Post-editing operated semi-automatically by the operator in which, the operator revises line by line, (paragraph by paragraph), the translation and if it is correct the operator passes it to the couple of upper fields (SourceRev,TargetRev FIG. 1) (stage in FIG. 2).
c) Selection of the translation error and/or its direct correction being carried out either as usual directly on the text or by means of the return window (FIGS. 3-4-5), both having the correct solution (E.g. “soluzione preferred=preferred solution” FIG. 8).
d) Teaching of the correction carried out, namely teaching of the second type according to the present invention, as above automatically or with a revision window (OK FIG. 7).
e) the correction is automatically memorized and placed in “store” (memory) for reuse or under the control of the operator (FIGS. 8-9).
f) Teaching of the first type, namely from the text in the source language to the text in the exit language (FIGS. 6-7), with the execution of the stages e)-f), first one and then the other or vice-versa or simultaneously and at least that of the second type (c)-d)-e)).
g) continuation of the revision and continuous movement after revision to the upper couple (FIGS. 10-11) until the end.

The term multi-tasking is understood substantially as multi-function, namely a computer capable of executing several operations simultaneously in parallel.

1. Computer translation method of the type using a connecting structure with intercommunication network/Internet (Net), whose network includes a plurality of interconnected servers (Serv1.Serv2.Serv3 . . . ServCUz . . . ServCUz), and using:
a) at least one user apparatus of the network communicator microprocessor (Cuz) for network communication (CU1.CU2.CU3 . . . ) which comprises connecting means to the network and or via network/Internet (ServCTRn-network), and
b) at least one network server (ServerCTRn) connected to said intercommunication network/Internet (NET) comprising an indefinite number of servers (Serv1.2 . . . );
c) said network service server (ServerCTRn) including or connecting at least one database by network service (Db); and
d) a plurality of translation computers and/or translator servers (Ctrn) comprising at least one internal automatic translation system for a plurality of languages in various combinations, each said translator computer and/or server-translator (Ctrn) including furthermore:
I. connection of means to said intercommunication network/Internet (ServCUz-network) and
II. automatic and repetitive supervision means in said database c) by network service (Db) to verify if at least one text to be translated is loaded,
III. respective pick up/download means of said text to be translated (SourceS),
IV. means to translate at least automatically said texts to be translated (SourceS) in order to obtain a translation (TargetDB) automatically and
V. means to send said translation (TargetDB) automatically to said database by network service (Db) and to continue the inspection for new texts in said database by network service (Db);
e) said network-connected user's computer a) (Cuz), similarly including:
I. means of sending data and said text to be translated (SourceS) to said database c) by network service (Db),
II. means for detection of said database by network service and verification if the respective translation has arrived (TargetDB), and
III. respective pick up/download means of said translation (TargetDB),
f) thus said network-connected user's computer (Cuz) can communicate by introducing data and sending the translation to be carried out and receiving the complete translation, only and exclusively with said database c) by network service (Db), and
g) in such a way that said translator computer and/or server-translator (Ctrn) communicate by introducing and capturing data in the stages of pick up/download and release of the translation only with said database c) by network service (Db),
h) said network service server d) (ServerCTRn) comprising interruption means or being without means to allow the direct connection between said network-connected user's computer a) (Cuz) and said computer and/or network translator server d) (Ctrn),
characterised in that said server (ServerCTRn) uses a multi-function and multi-processor or at least a dual processor computer, in which the following is provided:
aa) use of an integrated multiple-tasking or multi-function computer system with at least two processors,
bb) duplication of the translation system creating an identical couple of “stand-alone” translator systems functioning independently in said computer,
cc) creation of a text container capable of receiving texts from said couple of translator systems or allowing the reading of texts from said couple of translator systems,
dd) activation of one translator system of said couple as server of the other and the other as main translator so that both may have access to said text container, said server being equipped with means activated for continuously inspecting said container to verify if there are texts to be translated and, if the presence of a text is verified, providing the respective automatic translation and sending back the translation to said text container:
ee) dividing substantially into two parts of the text to be translated in which the first part to be translated has a greater number of words than the second part and simultaneously:
ff) sending said second part to be translated to said container, while starting the translation of said first part to be translated in said main translator:
gg) on completion of the translations in said main translator:
i. command said main translator to verify if said container contains the translated text of the second part and
ii—if said translation has been completed, add it to said first part and close the operation,
iii—otherwise if said translation has not been completed yet by said server, directly making provision for the completion of the translation;
and wherein in said network translation server (Ctrn) after each source-to target automatic translation, a second type of automatic translation is provided operating in target language to target language modality in order to harmonize the translation carried out independently of the source language;
and wherein each of said user apparatus (Cuz) is also capable of storing and showing a respective text of the source language to be translated and a text of the target translation language automatically made with the said features a), b) c) d), e) f), g), h), and wherein texts are placed on it in parallel adjacent contemporary sliding fields, said fields can be edited and their variations can be memorized in the form of at least two elements:
aaa) fragment of the target text from the automatic translation,
bbb) the same fragment of the target text modified by the operator,
ccc) the aforementioned elements being automatically memorized and constituting a teaching file for reuse in subsequent and future translations or revisions;

2. Computer translation system, capable of filing and showing a respective text of the source language to be translated and the text of the translation made according to claim 1, characterised in that said texts are placed in parallel adjacent contemporary sliding fields, and wherein said fields can be edited and the modifications made can be memorized in at least three elements:
a) fragment of the erroneous target text from the automatic translation,
b) the same fragment of the target text amended by the operator,
c) an instruction code to allow the adaptation of the teaching b) replacing the fragment of the erroneous target text and adapting it in accordance with the context of the entire sentence;
d) the aforementioned elements constituting a teaching file for reuse in future translations or revisions;

3. Computer translation method using a system according to claim 2, capable of filing and showing a respective text of the source language to be translated and the text of the translation, characterised in that
said teaching is automatically carried out by comparing the original text with the target text amended in auto-learning, said teaching file being interconnected with auto-learning means in order to memorize the uncorrected sentence fragment of the translation and its correction for immediate subsequent reuse.
said teachings being
i—captured by auto-learning means for memorizing the uncorrected sentence fragment of the translation and its correction and
ii—integrated in an automatic or semi-automatic transfer means via email of said corrections with respect to at least the revision of each revised text.

4. Computer translation method according to claim 1, characterised in that said teachings also include the corresponding part of the original text to be translated (Sorgenti/SourceRev).

5. Computer translation method according to claim 1, characterised in that it uses an user apparatus (Cuz) with a double couple of sliding fields respectively:
the lower couple that represents on one side the text to be translated (SourceS) and on the other side the text automatically translated (TargetDB) and
the upper couple that is the couple of revised texts originating from the lower couple by means of an action command by the operator after having line by line, carried out the revision, and representing for this reason:
i. the completely amended and revised text of the translation (TargetRev) on one side and
ii. the corresponding original text used as a source for the translation (SourceRev) on the other,
the upward movement being carried out by means of the parallel transfer action of the lower couple to the upper couple in the same number of lines, that is to say line by line, each time from below to above until the end of the revision.

6. Computer translation method according to claim 1, characterised in that:
a) said network-connected user's computer (Cuz) uses a translation post-editing device, said translation post-editing device having two superimposed couples of fields that slide in parallel (SourceRev-TargetRev, sorgenti-TargetDB) and
b) the source-text and the automatically translated texts are placed on a lower couple of two superimposed couples of fields in order to allow the following stages:
i. revision line by line to see if the translation is correct, making the corrections in said revision of the text on the fields in the target sector respectively (TargetDB) with respect to the corresponding line of the source text of the source field (SourceS);
ii. by means of automatic auto-learning means through the detection of modifications, predisposed in the system, the required target-to-target corrections made, are automatically memorized for reuse in the following sentences and in subsequent and future translations;
iii. the upper couple(s) of sentences/lines of the right and left texts revised in said couples of lower fields (SourceS, TargetDB), being transferred in parallel connection to an upper couple of revised-text fields (SourceRev.TargetRev);
iv. the cycle is repeated until the end;
v. at the end of the revision the entire revised text is made available for final use.

7. Computer translation method according to claim 6, characterised in that after completion of the revision, is provided to send automatically by e-mail to send the corrections, error and correction automatically memorized, to a predetermined target-to-target section with the aim of improving the translation system so that these errors will be considered in future releases, while the stand-alone system of the user already uses said corrections already stored in its memory.

8. Computer translation method according to claim 1, characterised in that in said user apparatus (Cuz) it is carried out the following steps:
a) automatic translation in the couple of lower fields with the source text on one side (SourceS) the resulting automatic translation on the other (TargetDB) is made according to claim 1;
b) post-editing is carried out semi-automatically by the operator in which, the operator revises line by line, the translation and if correct passes it to the upper couple of fields (SourceRev, TargetRev FIG. 1);
c) selection of the translation error and/or its direct correction, made directly on the text or by means of a return window, both leading to the correct solution;
d) teaching of the correction carried out, said teaching from the target language to the target language and
e) its stable memorization for subsequent reuse automatically or semiautomatically;
f) possible teaching also from the source language to the target language, simultaneously and/or first one and then the other or vice versa.
g) continuation of commands and continuous movement after revision from the couple of lower fields to the couple of upper fields until the end.

9. Computer translation method according to claim 8, characterised in that in said user apparatus (Cuz), during the post-editing stage a)-g) the lines, that progressively arrive at the top of the couple of lower fields (SourceS, TargetDB) are always retranslated in targeto-to-target and/or at least automatically revised again by means of auto-correction on the basis of the corrections previously introduced as well as those stored in the memory from previous teachings in accordance with the respective corrections.

10. Computer translation method according to claim 9, characterised in that said in said user apparatus (Cuz) teachings and corrections are also carried out in the couple of upper fields (SourceRev, TargetRev) but always by paragraph or line correspondence.

11. Computer method according to claim 9, characterised in that in said user apparatus (Cuz) said fields for housing the source text (SourceS, SourceRev) are those on the left and said target fields (TargetDB, TargetRev) are those on the right, and in that the translation teaching corrections are carried out in correspondence with the fragment of text from a left field (SourceS, SourceRev) toward the corresponding right field (TargetDB, TargetRev) of the same couple.

12. Computer translation method according to claim 9, characterised in that in said user apparatus (Cuz) said fields for housing the source text are arranged in a column on the same side (SourceS, SourceRev) and said target fields are also arranged in a column on the opposite side (TargetDB, TargetRev) placed in a pair, and in which:
a) the translation corrections and teaching are carried out in correspondence with a fragment of text from one side to the other in correspondence with the couple of fields
b) said corrections and teaching of the second type, namely operating on the exit translation in target language to target language modality for harmonization are carried out in the same field and the same paragraph under consideration.

13. Computer translation method according to claim 9, characterised in that in said user apparatus (Cuz) said fields for housing the source text (SourceS, SourceRev) are those on the left and said target fields (TargetDB, TagetRev) are those on the right.
